(19) United States
(12) Patent Application Publication
(10) Pub. No.: US 2024/0221010 A1
(43) Pub. Date: Jul. 4, 2024

(54) SYSTEM AND METHOD FOR PREDICTIVE AND SCORING OF FUTURE SUCCESS OF BUSINESSES AND/OR PRODUCTS

(71) Applicant: BROADHAVEN, INC., Worcester, MA (US)

(72) Inventors: David Andrew Cook, Luton (GB); Andrew Michael Williams, London (GB)

(73) Assignee: Broadhaven, LLC, Worcester, MA (US)

(21) Appl. No.: 18/401,829

(22) Filed: Jan. 2, 2024

Related U.S. Application Data
(60) Provisional application No. 63/436,465, filed on Dec. 30, 2022.

(51) Int. Cl. G06Q 30/0202; G06Q 10/0637; G06Q 30/0282; G06Q 30/0601

(52) U.S. Cl. CPC G06Q 30/0202; G06Q 10/06375; G06Q 30/0282; G06Q 30/0629

(57) ABSTRACT

The system and method forecast the future success of a company and/or product based upon historical popularity and performance data. The system and method analyze, score, and rank a company or product based upon how likely it is to succeed based historical and current popularity, consumer sentiment, sales, trend, ethicality, and financial health data. A computer-implemented method for swapping a selected product for a product having a higher attribute, or sustainability score analyzes the selected product to determine its score, finds products that are similar to the selected product, determines a sustainability score for each similar product, then ranks the similar products by similarity and corresponding sustainability score. One of the highest ranked similar products can then be swapped for the selected product if its sustainability score is higher than the sustainability score of the selected product.

### RELATED APPLICATIONS

This patent claims priority to and benefit of U.S. Provisional Patent Application No. 63/436,465, filed Dec. 30, 2022. All documents cited in this section are incorporated in full here by reference.

### FIELD OF THE DISCLOSURE

The present disclosure relates to estimating the future success of a business or product utilizing historical popularity and performance data, and more specifically, to a system and method for estimating future success of a particular business or product by utilizing the analyses, scores and ranks on how likely it is to succeed in terms of future popularity and sales and is particularly well suited for online shopping and product recommendations as well as to retail, commerce and financial technologies.

### BACKGROUND OF THE DISCLOSURE

Many shoppers are frequently motivated to purchase products that were made using a specific characteristic and/or made by a company/producer in line with a specific characteristic in which they wish to support. For example, shoppers frequently choose products based on the perceived moral values and/or ethical values of the product and/or the producer of that product. For example, some shoppers may choose to support women-owned businesses or ingredients grown by a women-owned farms. Other shoppers may wish to support sustainable products and ingredients and therefore may base their purchase decisions on the level of sustainability of the product and/or the ingredients and/or the manufacturer/company itself. Additionally, companies and consumers often base buying decisions upon perceived or anticipated popularity of a product, or company, which can also be tied to the foregoing characteristics.

However, determining the detailed characteristics of ingredients in a product, and/or the manufacture methods of that product, and/or the producer of that product, as well as performance, location of the facility, distance the product is shipped, etc., is difficult and extremely time consuming at best, for a user to determine for each product or service they wish to buy or company that they wish to conduct business with.

### SUMMARY OF THE DISCLOSURE

A system and method for providing targeted information to users based on that user's own preferences, including at the point of sale, is disclosed. A system and method for suggesting products and/or businesses that meet the user's own preferences is disclosed. Wherein a system and method for online e-commerce shopping with product and business recommendations as well as proposing alternatives such as by swapping for same at checkout is also disclosed.

One embodiment of this disclosure provides a method and/or system for determining the future popularity and likely success of companies and products. The analysis and ranking may be based upon historical and current popularity, consumer sentiment, sales, trend, ethicality and financial health data. This includes garnering insights on historical and future performance by gathering, inputting, and analyzing data relevant to certain metrics, including for example, consumer sentiment, sales, industry and cultural trends, ethicality, financial health and other relevant data. The data may be collected throughout ancillary touchpoints, including for example, as provided by social media, mobile applications, web applications, dynamic advertisements, and communications such as email. Based upon the data and analysis for a given product or company, a user of the system will be presented with a performance or “breakthrough” score predicting and ranking how likely that given company or product is to be popular or financially successful in a particular geographical market, vertical or category in the future. The breakthrough score can also be utilized to provide a ranked list of the most desirable companies or products in the chosen space overall.

Another embodiment of this disclosure includes a method and/or system for swapping a selected product for one that is more popular or in-line with a particular user's own preferences, for example, one with a higher sustainability score. The method includes analyzing a selected product to determine the desirability of the product, for example, the sustainability score of that selected product; finding a swapping product, wherein finding a swapping product includes identifying products similar to the selected product, with similarity being determined by factors such as the character, quality, and capabilities; determining the desirability of the swapping products by comparing an attribute score (for example, a sustainability score) of those products similar to the selected product; ranking the products similar to the selected product for swapping by both similarity and sustainability score; and selecting a swapping product from the products similar to the selected product, wherein the swapping product ranks high in similarity to the selected product, and includes a higher sustainability score than the selected product; presenting the swapping product; and swapping the selected product for the swapping product.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

Various aspects of at least one embodiment are discussed below with the reference to the accompanying figures, which are not necessarily drawn to scale, emphasis being placed upon illustrating the principles disclosed herein. The figures are included to provide an illustration and a further understanding of the various aspects and embodiments and are incorporated in and constitute a part of this specification but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For clarity, not every component may be labeled in every figure.

FIG. 1 is a diagram illustrating the system according to one embodiment;

FIG. 2 is a diagram illustrating the attribute score, according to one embodiment;

FIG. 3 is a diagram illustrating the breakthrough score, according to one embodiment;

FIG. 4 is a flowchart of a method for recommending a swapping product;

FIG. 5 is a diagram illustrating the method for swapping a user selected product for a swapping product, according to one embodiment;

FIG. 6 is an object illustration diagram for reviewing and voting on a brand/product according to one embodiment;

FIG. 7 is a flowchart of a method for calculating scores, according to one embodiment;

FIG. 8 is an object illustration diagram for score processing, according to one embodiment;

FIG. 9 is an object illustration diagram for the alternatives engine, according to one embodiment; and

FIG. 10 is an object illustration diagram of the system for the score processing.

### DETAILED DESCRIPTION OF THE DISCLOSURE

In various embodiments, the system is a Software as a Service (Saas) platform that provides a system and method for distributing information regarding a product or company, based upon characteristics that the shopper or investor has defined as important to making their buying decision. For example, in some embodiments the platform may include information relating to sustainability or information regarding the future success of a product or company. The term “sustainability” refers to a holistic approach that considers varies impacts, including at least one of the following: the social, environmental, and/or economic impacts of actions and decisions taken today on the future. However, in other embodiments, these characteristics are not limited to sustainability and/or success, but may include, and are not limited to, one or more of the following: ethically sourced; morally sourced; woman and/or minority-owned business; ingredients from a preferred region in the world, popularity, product availability, economic viability, and/or any other desirable characteristics.

Various embodiments are described below with reference to block diagrams and flowchart illustrations of methods, apparatuses (e.g., systems) and computer program products. Each block of the block diagrams and flowchart illustrations, and combinations of blocks in the block diagrams and flowchart illustrations, respectively, can be implemented by a computer executing computer program instructions. These computer program instructions may be loaded onto a general-purpose computer, special purpose computer, or other programmable data processing apparatus, such that the instructions execute on the computer or other programmable data processing apparatus to implement the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, are not limited to the order in which they are presented.

In various embodiments, the analysis for a company and ranking is based upon historical and current popularity, consumer sentiment, sales, trend, ethicality, and financial health data. Historical performance data for a given product or company is set against key success indicators to predict its future likelihood to be popular and financially successful. Popularity data includes, but is not limited to, consumer sentiment and brand awareness data, social media presence in terms of reach, engagement, quality of content and regularity. Sales and financial health data includes, but is not limited to, historical revenue, financial records, and accounts. The platform may additionally provide a single source for product reviews, analytics, sourcing statements, and a showcase of products and/or companies.

In various embodiments the platform provides a single source for product reviews, analytics, sourcing statements, and a showcase of products. In various embodiments, the platform provided allows for the company who provides the product to engage with the user, respond to the user, add more “color,” and supply information at the point of engagement with the user. Additionally, in various embodiments, the platform allows the company to add discount codes, links, etc., to auto-invite or send out invites to promotions, to leverage having the user's attention by providing one or more widgets that allow for comments to be fed into the platform. Also, in various embodiments, the platform allows the company to review benchmarking against the competition and showcase how the company is doing versus the competition. In some embodiments, the platform provides an ability to make statements, e.g., to normalize a sustainability strategy (or any strategy related to the characteristics for which the consumer has indicated an interest). For example, if a user is reviewing ingredients of a product, in various embodiments, the platform includes the company statement regarding sustainability at that point, i.e., where the ingredients are listed. This may be beneficial/desirable for many reasons, including, but not limited to, allowing the user to read about the product plus review the company statement regarding the sustainability of that ingredient and/or product. Thus, the user may make informed decisions about buying that product based, at least in part, e.g., on the sustainability of the ingredients in the product and/or the overall sustainability of the product (or based on any characteristic that is important to the user).

In various embodiments the platform includes a swapping feature for products. In these embodiments, any product in which a user indicates interest, and, in some embodiments, while reviewing the user's “shopping cart” or otherwise saved items, suggested products that include a higher score for the characteristic in which the consumer is most interested, e.g., sustainability, minority owned, small business, or the like, and the user may “swap” the item in their cart for the suggested product, i.e., the product with a higher score. The system disclosed herein in one embodiment includes identifying products with high ecological impact and swapping them with lower ecological impact products to reach a user's targets quicker. More details regarding the swapping feature are discussed below.

In various embodiments, the platform also includes breakthrough scores. A breakthrough score is a score indicating the predicted success of any given product and/or company. A breakthrough score may be determined by the platform after analyzing the data relevant to certain metrics, including for example, consumer sentiment, sales, industry and cultural trends, ethicality, financial health, etc. The breakthrough score gives the product provider/company/investor a predictive rating of success. Additional details regarding the breakthrough scores are discussed below.

In various embodiments, the system disclosed uncovers and/or targets desirable audiences through demographic and psychographic insights, to help a company/seller/business/investor to increase reach, find new influencers, and be more relevant in new spaces. This is discussed in more detail below.

The system disclosed herein also unifies, e.g., by integrating billions of social, blog, news, followers and business data points. In various embodiments, this includes both real-time and historic data. The system normalizes in a single data model, and unlocks by enriching and bringing context to human data. In various ways, the system mines for the most relevant insights, classifies and reveals hidden patterns, and delivers to users via API or WF online platform. The system is beneficial/desirable for many reasons, including, but not limited to, in use, the system allows users to discover new products and companies, and their likelihood of success on their store shelves or in general; and/or the system connects with hundreds of thousands on the platform, from consumers to brands and certification bodies.

In one exemplary embodiment disclosed herein, the platform is referred to simply as the “Platform” and is an example of a platform that provides a system and method for distributing information regarding a product, or company, based upon characteristics that the shopper or investor has defined as important to making their buying decision. In one embodiment the platform may include information relating to desirable characteristics/attributes that may include sustainability or other desirable product attributes such as geographic sourcing, minority ownership, inventive products, chemical free, or any number of other desirable characteristics. In yet another embodiment, the platform may include information regarding a company and the future success of a product or the company as a whole.

The platform bridges that gap between people, brands, retailers and certifiers using the most comprehensive data set on sustainability credentials, sustainability sentiment, and/or other desirable product characteristics that are pre-defined. In some embodiments, the platform is a sustainability review and education platform for consumers. In other embodiments, the platform is a sustainability communications platform for brands and in some embodiments, is a data intelligence platform for retailers. Likewise, in some embodiments the platform is a review and education platform for consumers, investors, and others to share and obtain information regarding companies and their products, including current and potential success. In other embodiments, the platform is a communications platform for Companies and brands, and in some embodiments, it is a data intelligence platform for investors.

Likewise, the platform, in some embodiments, is a networking tool for accreditors, certifiers, and evaluators to find new companies in which to partner. In some embodiments, the platform includes many additional benefits and is desirable for many reasons, including, but not limited to, as a platform, method and/or system for companies to build their sustainability strategies in partnership with their customers and/or to build and selectively share with users its anticipated future value and that of its products.

In many embodiments, the platform is a tool for retailers, buyers, investors, and other stakeholders to discover which products and/or companies will have the greatest likelihood of success. The granularity of data allows retailers to target specific types of shoppers, specific types of products, and get deep insights about consumer trend and sentiment around sustainability as well as other desirable topics as may be desired.

This disclosure includes examples and reference to specific characteristics a user may wish to prioritize when shopping, etc. These are meant as exemplary embodiments for the purposes of disclosure and are not intended to limit the scope of the system and methods disclosed herein. For purposes of disclosure, the system and methods disclosed below with respect to attributes are disclosed with reference to sustainable or ethical product characteristics. However, the systems and methods disclosed herein may be used with respect to any desired characteristic of any product and/or company.

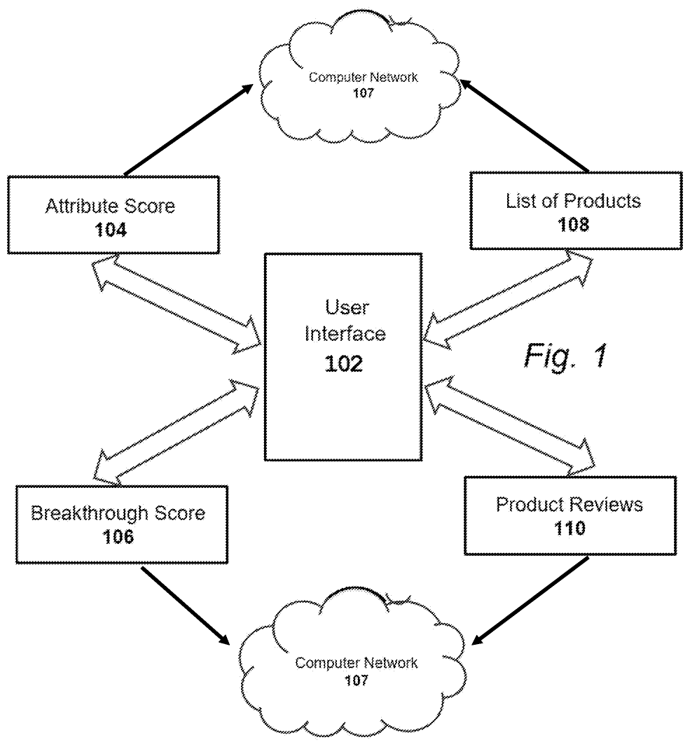

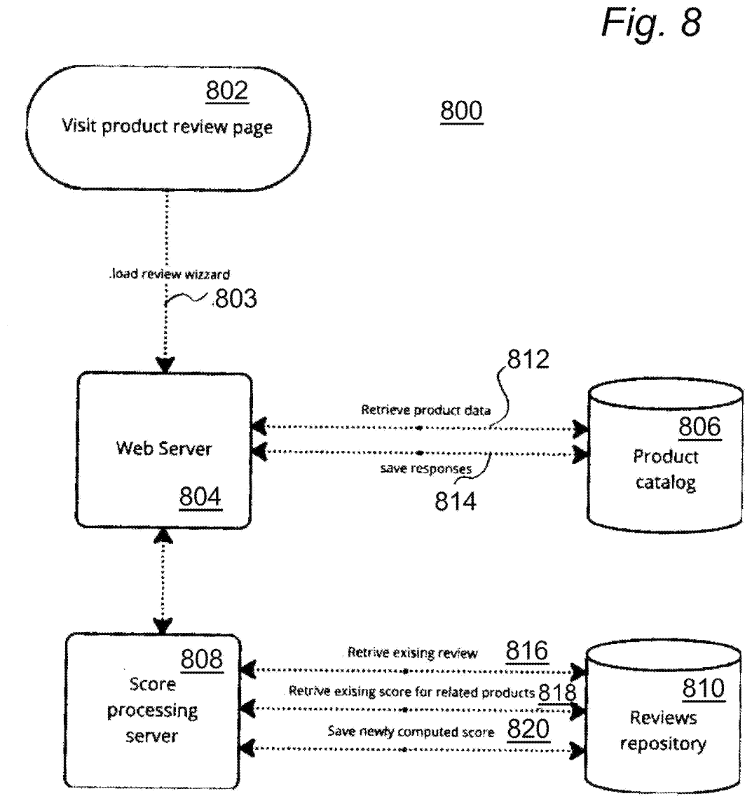

Referring first to FIG. 1, the system 100 includes a user interface 102 that provides an interface for user(s) to access a computer network 107 comprising one or more servers, 804, 808 (FIG. 8), which operate to receive, analyze, store and share data as described in greater detail herein. Data that is stored on the servers 804, 808, includes but is not limited to a product's attribute score 104 (in one example a sustainability score), a breakthrough score 106, a list of products 108 and product reviews 110. The user interface 102 may include, for example, a monitor or screen and an input device such as a mouse, keyboard, or touch screen, as would be known to those of skill in the art to access the computer network 107.

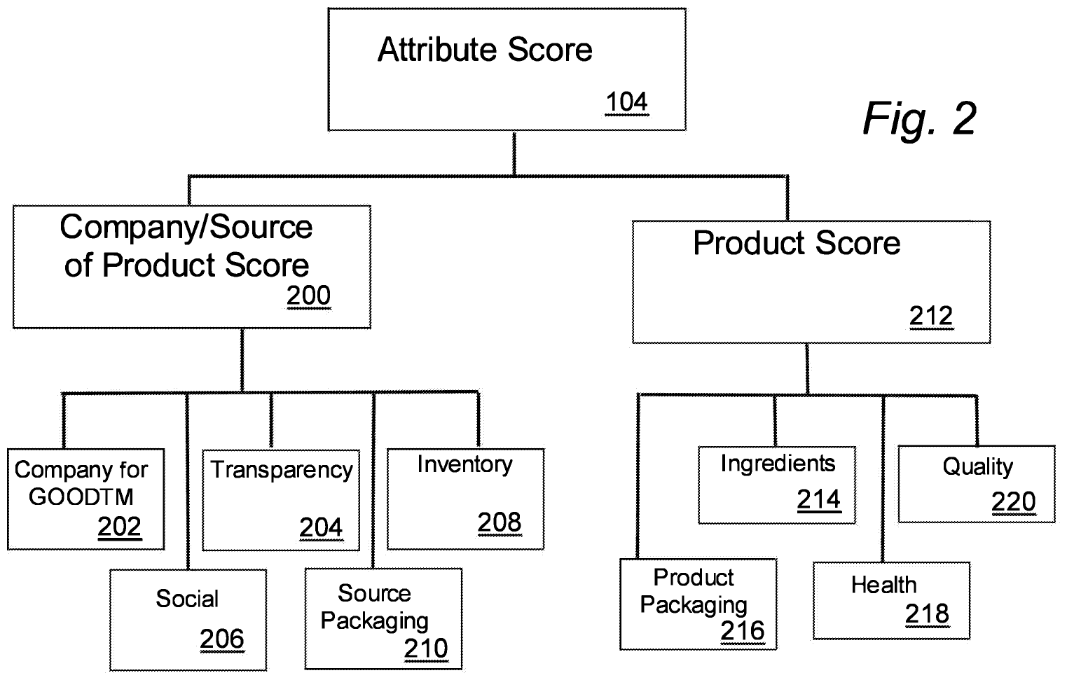

Referring also to FIG. 2, the attribute score 104 is a score that includes a numerical representation of several factors contributing to the sustainability and/or ethicality of a product, and/or the company/product manufacturer in the present embodiment. The attribute score 104 is determined by using a number of variables, including, but not limited to, the company/source of the product(s) score 200 and the product score 212 itself. The company/source of product 200 likewise includes many variables, including, but not limited to: company for Good™ rating 202, transparency 204, social/environmental and/or economic impact 206, inventory 208, and source packaging 210, along with any other desired characteristics. The product score 212 includes many variables, including, but not limited to, ingredients 214, product packaging 216, health 218, and quality 220, along with any other desired characteristics.

The term sustainability is a multi-faceted representation of many and varied factors that considers varies impacts, including at least one of the following: the social, environmental, and/or economic impacts of actions and decisions taken today on the future. Examples of these include (but are not limited to): 1) the ecological and environmental impact and/or debt a business/company produces in the process of operating, as well as manufacturing and distributing their products and services. This may include, but is not limited to, one or more of the following: carbon production; energy usage; water usage; materials; and/or any other relevant markets, which, in various embodiments, may also be industry-specific; 2) the way companies interact with their employees and/or people that operate within their supply-chain and the communities in which they operate; and 3) the way in which companies govern and manage their company. This may include everything from how transparent the company is in its operations, to the distribution of rights and responsibilities amongst different participants in corporations, including the board of directions, managers, shareholders, and stakeholders. The factors that are used to score wherefrom or company score 104 may also be weighted, with the more important criteria being given more weight, than other less-important criteria, as desired. As will be appreciated, the factors that are considered for achieving a product and/or company score, for example using Wherefrom or CompanyPro or another platform, can be tailored to the particular circumstances and weighting of the most important criteria for those circumstances.

In various embodiments, the attribute score 104 is based on crowd-sourced reviews. In this sense, it is a sentiment score, i.e., a score representing the opinion of multiple customers/shoppers (which may also be referred to as “consumers”) when asked how they would rate the given company or product. Thus, it is a representation of the general sentiment or impression in the marketplace of customers/shoppers regarding the level of sustainability (or other criteria) of a given product or company. In various embodiments, a company score 200 may also take into account the average score of the products 212 that company makes, while the product score 212 may also use the company score 200 as one factor to create the product score 212. In various embodiments this may be accomplished by using a ratio of each. Thus, in some embodiments, a company score may be made up of a blend of 40% company votes and 60% product votes. A product score, in various embodiments, may be made up of 50% company votes and 50% product votes. Again, the weight or percentage is determined by the attributes that are most important for the circumstances and/or use of the data.

The company score 200 may be determined using a plurality of factors, including, but not limited to, the company for Good™ rating 202, transparency 204, social 206, inventory 208, and source packaging 210. In various embodiments, the company for Good™ 202 is a measure of how much consumers/shoppers trust the company in question has a clear social and environmental mission and is attempting to make a positive impact on people and the planet. Transparency 204, in various embodiments, refers to a measure of how transparent customer/shoppers think a brand/company is in their sustainability and/or other reporting. Social 206, in various embodiments, refers to a measure of how much consumers trust a brand ensures good labor rights, conditions and benefits for their staff, community interaction, and the like. Inventory 208 refers to, in various embodiments, what users/customers/shoppers believe the level of sustainability the products that are regularly in stock and offered by a particular company are in general. In some embodiments, source packaging 210 refers to how sustainable users/customers/shoppers think a brand or company's packaging is in general.

With respect to the product score 212, this may include factors such as ingredients 214, product packaging 216, healthy benefits 218, and quality 220 of the goods and other factors, as desired, for example pricing/value. Ingredients 214 in one example refers to a measure of how much users/customers/shoppers trust that a product's ingredients and materials have been sustainably sourced and/or the quality of the ingredients. Product packaging 216 in one example refers to a measure of the level of sustainability of a product's packaging 216 from users/customers/shoppers perception and/or the overall quality of the packaging and branding. Quality 220 refers to the user/customers/shoppers measure of the overall quality of a product and pricing refers to not only the actual price of the product but the value.

In various embodiments, the sustainability/ethicality opinions/ratings for the company 200 or product 212 are collected from a multitude of sources. These sources may include, but are not limited to, one or more of the following: partnerships with data licensees, including accreditors, certifications, and associations; companies themselves, i.e., data provided from the company being rated; web scaping, i.e., information from various data pipelines across the Internet; and people, i.e., users/customers/consumers/shoppers themselves, also directly from users of the attribute score 104. In various embodiments, these sources are regularly updated, and in some embodiments, continuously updated, aggregated and normalized.

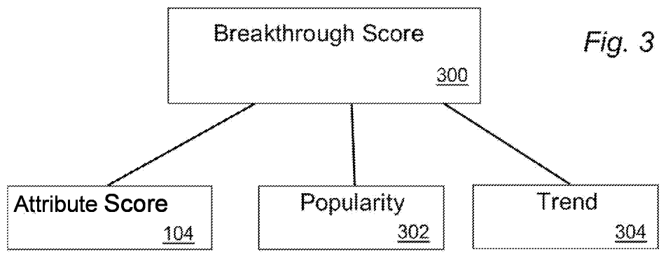

Referring now also to FIG. 3, in various embodiments, a breakthrough score 300 is determined for each product. The breakthrough score is an indication of a prediction of the success of a product. The breakthrough score 300 is determined by using proprietary data regarding a product, e.g., provided by the company or source of the product, and blending it with third-party analytics data. In various embodiments, the third-party analytics data is focused on attribute score 104, popularity 302 and trend 304 of the product to create a single-source of data that gives a predictive analysis of success of any given product. Marks of popularity may include those from any source that represents popularity, e.g., the number of Instagram® followers or web traffic to the product per month, amongst other indicators that may vary. However, the marks of popularity include those factors that, at the time the breakthrough score 300 is calculated, are accepted in the field as indicators of popularity. These are given a weighting to create an overall popularity score out of 100. In various embodiments, that popularity score 302 may constitute 33% of the overall score of 100, the other 67% coming from attribute score 104 (determined as discussed above) and trend 306 data (weighted similarly to attribute score 104). Other weighting, with different percentages may be utilized, as would be known to those of skill in the art.

In various embodiments, the popularity data 302 may be scraped and collected from online sources. These online sources may include, but are not limited to, one or more of the following: social media reach and engagements, search term popularity and analysis, and/or website traffic statistics. In various embodiments, this is collected and analyzed historically to provide trend data 304, e.g. X search term has been searched for Y % more this month versus last month. The exact weighting of each social media or other source of trend data or popularity data may vary based on the product at issue and/or the various social media sources that are viewed as reliable indicators of popularity.

Determining the breakthrough score 106 is beneficial/desirable for many reasons. These reasons include, but are not limited to, the ability to determine the products that will have the greatest likelihood of success, which may also influence the company score 200 because it may include the average score of the products 212 that company makes, as discussed above. The granularity of data used to determine the breakthrough score 106 allows retailers/companies to target specific types of customers/users/shoppers, specific types of products and get deep insights about consumer trend and sentiment around, e.g., sustainability. In other embodiments, the sentiment targeted may include other/different characteristics, but in each embodiment, the method may be similar or the same to those disclosed herein with respect to sustainability.

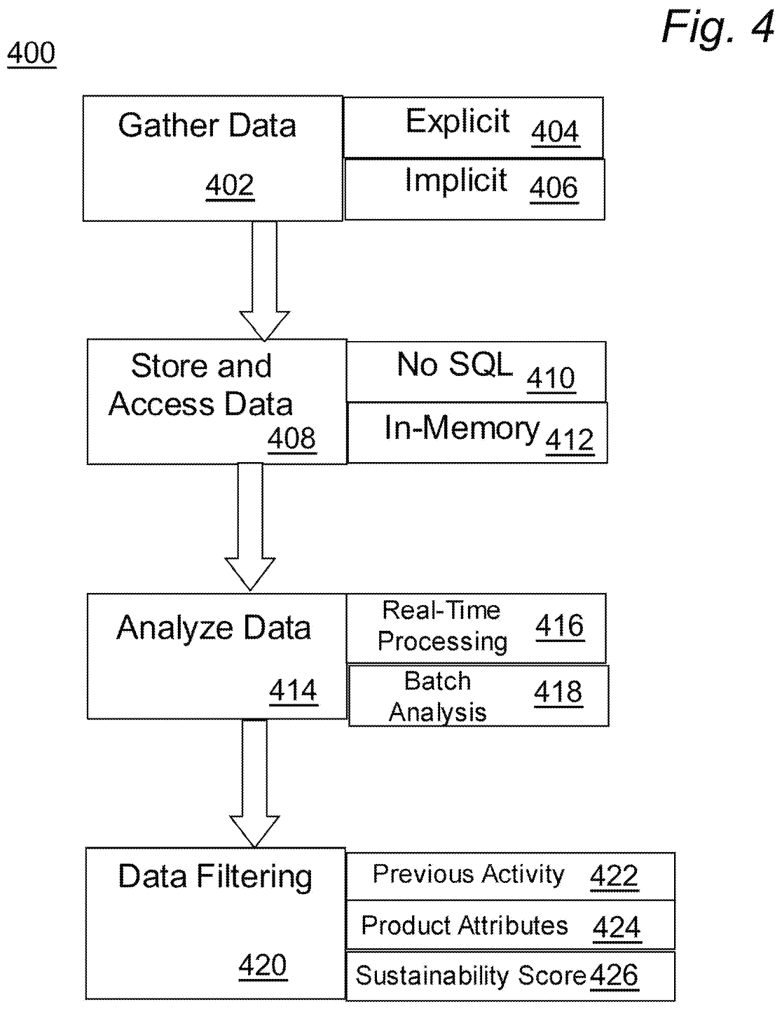

Referring now also to FIG. 4, in various embodiments, the platform includes a swapping feature. The swapping feature includes the functionality of suggesting products to “swap out” for those in which a user/consumer shows interest, e.g., has added to their cart, with products that have a higher score related to a characteristic the user/consumer has shown an interest in prioritizing, e.g., sustainability. Thus, as discussed above, the sustainability score (or other characteristic score) for each product and/or each company that provides products may be determined and the resulting attribute score 104. The attribute score 104 may be used to suggest alternative products to the user/consumer and therefore, allow the user/consumer to consider the alternative product, along with the attribute score 104/sustainability score and swap out the product in their shopping cart for another, similar product having a higher attribute score 104.

Therefore, disclosed herein is a search engine, platform, and/or method that allows online shoppers and/or users/consumers to be recommended more sustainable or ethical product alternatives to those they have shown intent to buy, i.e., have added to their shopping cart or are reviewing product information in a particular category of products based upon the crowd-sourced data, as discussed above. In various embodiments, a user/consumer may show interest in a product and/or category of product through browsing items or adding items to their shopping cart or otherwise saving the items. The platform/engine/method and/or system disclosed herein may recommend alternative products, where applicable and if available, of interest based on a similarity score and a sustainability or other score, herein also referred to broadly as an attribute score 104. An attribute score is a score that calculates a value for a desirable product characteristic, such as sustainability.

Thus, disclosed herein in one embodiment is an online e-commerce shopping system and method that provides recommendations during the shopping experience/in real time and throughout ancillary touch-points, e.g., mobile apps, web apps, dynamic adverts and communications, e.g., emails. In various embodiments, once a user/consumer shows intent to purchase a product they are then shown the most similar and relevant alternative product in which to potentially swap it with, i.e., one that is more, e.g., sustainable and/or ethical. In various embodiments, suggested alternatives for swap may be based on what the most relevant and direct swap possibility may be, e.g., a product that may be simultaneously more sustainable and/or ethical. Suggested alternatives, i.e., swap candidates, may be ranked and presented based on sustainability and/or ethicality score, and alternatively, product alternatives that exceed a given sustainability rating may be further ranked/sorted based on similarity.

Still referring also to FIG. 4, the platform/engine/method for recommending a swap 400 includes a first step of gathering data 402. To suggest swaps, data 402 must be gathered and stored to be accessed by the computer network 107 (FIG. 1) to create a database/index/lookup. There are two types of data the system uses to improve and recommend options to the user. These are explicit data 404 and implicit data 406. The explicit data 404 includes attributes about the product that are quantifiable, for example ingredients, nutrients, allergens, manufacturer, packaging, etc. These attributes may be either provided by the retailer/company that produces the product, or by a data aggregator which works closely with the retailers, or other reliable sources. The second type of data is implicit data 406 and is provided/collected from the behavior that users have when interacting with the product, for example on the website, e.g.: pageviews, clicks, items in the cart, search logs, etc., and may also include data from other sources that the user interacts with, for example from advertising, social media, etc. The more of these two types of data 404, 406 the system/engine ingests, the more robust it becomes over time.

Once the data 402 is gathered and stored it can be accessed in step 408. Storing and accessing the data 402 by an efficient and robust engine/platform to allows large amounts of data to be stored and accessed in a short period of time, preferably near real-time. For this step 408, in some embodiments, a NoSQL database 410 is used and the information may be stored on a server 804 (FIG. 8), which can be remote or local. In one embodiment, the database 410 is combined with in-memory storage 412, which, in various embodiments, may be for example Redis, for quick access to the most accessed data. This step 408 is useful for the long-term feasibility of the engine/platform as the data gathered and stored becomes more robust.

Still referring also to FIG. 4, once the data is gathered and stored, is analyzed in step 414. Analyzing the data 414 is a task that may be split into two types of processes: near real-time processing 416 and batch analysis 418. The largest set of the data is analyzed 414 by a batch analysis 418 process. The batch analysis 418 process intakes all the existing data about a product and/or company. This process may be beneficial/desirable for many reasons, including, but not limited to, that this batch analysis 418 process is more convenient and viable due to the fact that it yields better results. The second process, real-time processing 416, evaluates a stream of new product or company information, and in various embodiments, is faster compared to batch analysis 418 processing, and the results may be consumed right away. This process is used to create recommendations more efficiently and in a much quicker manner, i.e., before the batch analysis 418 processing system can create any results. The underlying technology that makes these processes powerful are complex machine learning algorithms that can cluster and rank the products based on their implicit and explicit labels. The concepts of Term Frequency (TF) and Inverse Document Frequency (IDF) are used in information retrieval systems and also content-based filtering mechanisms (such as a content-based recommender). These may be used to determine the relative importance of a product. TF is the frequency of a word in a document. IDF is the inverse of the document frequency among the whole corpus of documents. In various embodiments, TF-IDF is used for many reasons, including, but not limited to, because common words or prepositions that otherwise do not bring value to finding similarities (i.e. “the”, “a”, etc.) need to be weighed as being less important. In order to determine which products are closer to each other, the engine/method/system/platform uses the Vector Space Model to compute the proximity based on the angle between the vectors. In this model, each item is stored as a vector of its attributes (which are also vectors) in an n-dimensional space and the angles between the vectors are calculated to determine the similarity between the vectors.

The next step in the disclosed method is data filtering 420 (FIG. 4). Data filtering 420 includes filtering the results to provide more relevant recommendations for each specific user. This takes into account multiple factors, including, but not limited to, the previous activity of the user to product attributes and the computed sustainability score/attribute score 104.

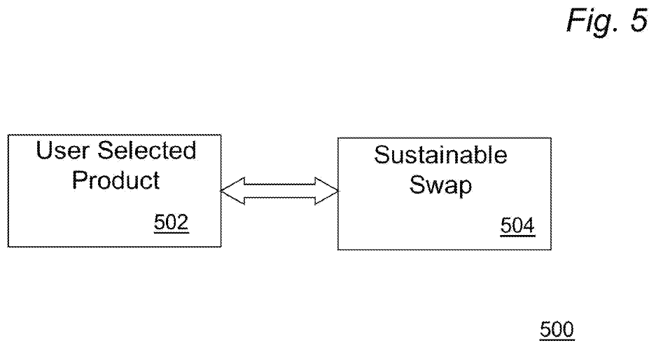

Referring now also to FIG. 5, in various embodiments, a method and system for recommending a product to a user/consumer/shopper that may be considered a similar product to the user selected product 502, but having a higher score with respect to a sentiment category, e.g., sustainability, ethicality, etc., is disclosed. The method includes the user selecting a product 502, then the engine/platform presenting the user with swap candidates using the method/system disclosed herein, the user selecting a swap candidate, and the engine/platform swapping out the previously selected product with a sustainable product, i.e., a sustainable swap 504.

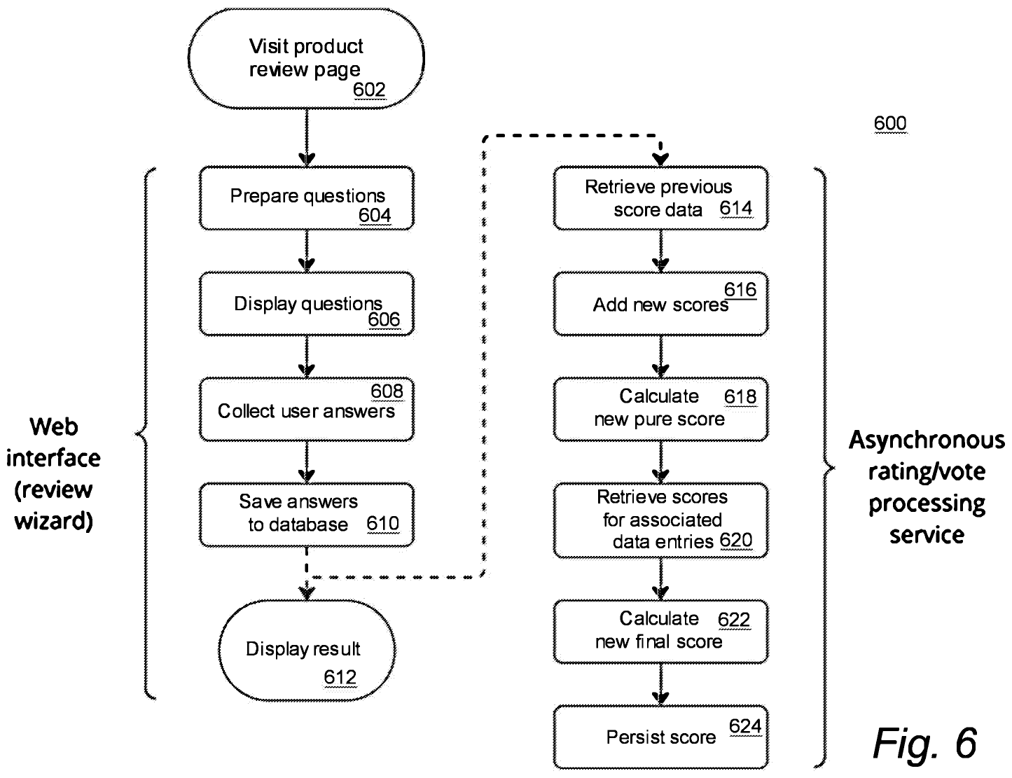

Referring now also to FIG. 6, to determine the attribute score 104, i.e., the sustainability and ethicality score in the present embodiment, for each product score 212 and brand/company/source of product score 200, in various embodiments, includes collecting crowd-sourced reviews for each product and company/source of product as discussed herein. This method of determining the attribute score 104, i.e., the sustainability and ethicality score in the present embodiment, includes a method/system for product and brand review.

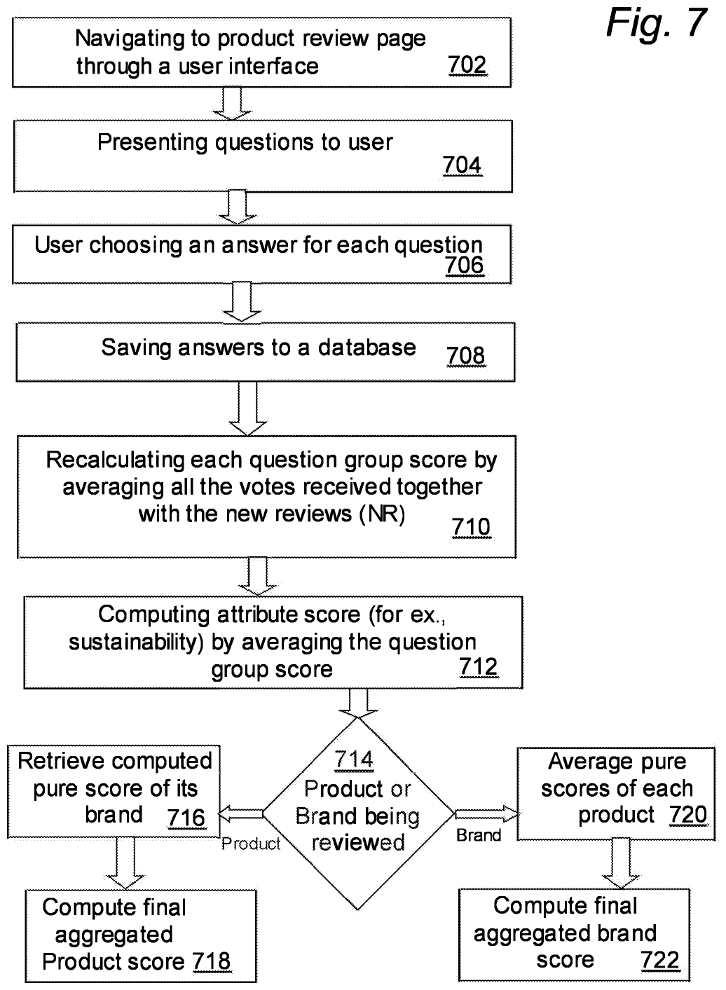

Referring now also to FIG. 7, the method for product and brand review 700 includes having a user 105 navigate to a product review page 702, then presenting questions to the user 105, the user choosing an answer for each question 706, all of which can be done through the user interface 102 (FIG. 1) and saving the answers 708 to the web server 804 (FIG. 8). The engine/method then recalculates each question group score by averaging all the reviews received together with the new reviews (NR) 710, then computing an attribute score 104 (in the present embodiment sustainability) by averaging the question group score 712. The terms “question” and “question group” are discussed in more detail elsewhere in this disclosure. Whether the user is reviewing a product or a brand influences the next step. If the user is reviewing a product, then the engine/method/system retrieves computed pure scores of the brand 716 and computes a final aggregated score 718. If the user is reviewing the brand, then the engine/method averages the pure scores of each product 720 and computes a final aggregated brand score 722.

Referring again also to FIG. 6, a process diagram for rating a product or brand is shown. Whether a product or a brand is being reviewed, the rating process is the same. The method/process is described herein with reference to a product, in other embodiments, the same steps may be used for collecting ratings on a brand. The method includes having a user 105 navigate to a product review page 602/702, preparing questions for the user to answer 604, displaying the questions 606, collecting user answers 608, saving answers to database 610, and displaying result 612 to the user 105. These steps 602-612 are included/presented through the loading the web interface/review wizard 803 and can be accessed and completed through the user interface 102 (FIG. 1).

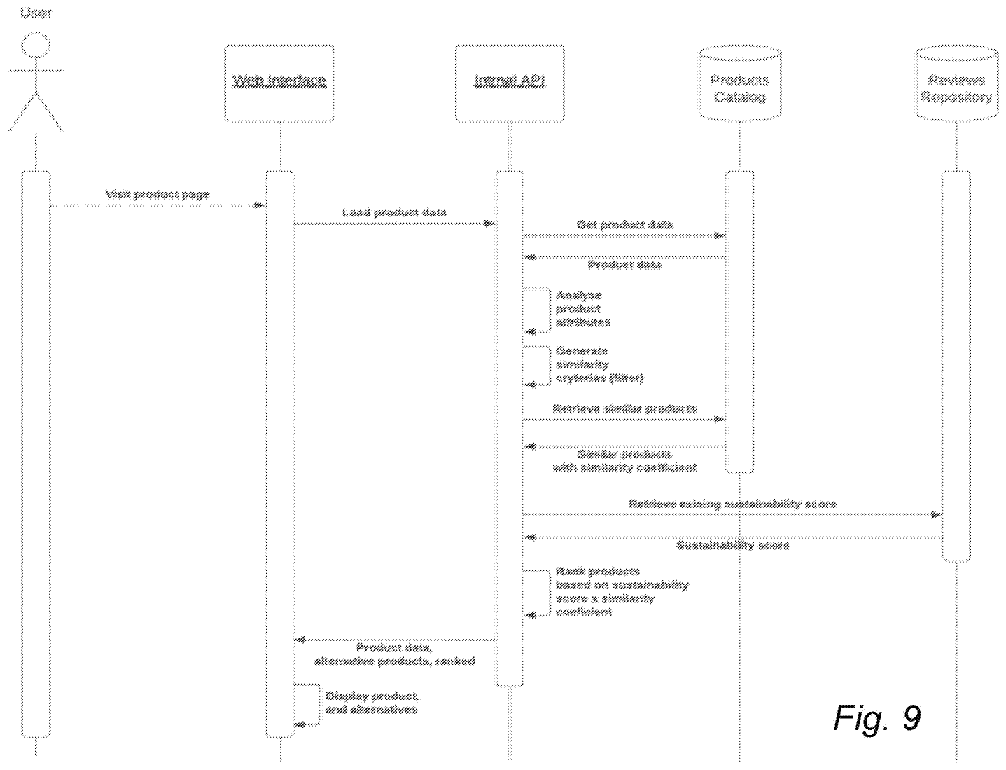

The following steps 614-624 are included in an asynchronous rating/voting processing service. These steps include retrieving the previous score data 614 stored on a score processing server 808 (FIG. 8), adding the new scores 616, calculating new pure score 618, retrieving scores for associated data entries 620, calculating new final score 622, and determining the persist score 624. The scores are then processed and can be saved to the score processing server 808 to be made available to the system and alternatives engine (see FIG. 9 and discussion below regarding same). The process diagram for rating/voting on a product illustrated in FIG. 6 is the same process that can be utilized for reviewing businesses. For either products and/or businesses the scores are then processed, saved to a server, and made available through the computer network.

Referring now to FIG. 8, in various embodiments, a method of score processing 800 is disclosed. Score processing 800 is initiated when a user 105 visits a product review page 802, which loads a review wizard 803 accessibly by the computer network 105. The user interacts with the product review page 802 through a user interface 102, as discussed above. The computer network 105 (which may include without limitation system/engine/platform) and product review page 802 may be accessed through a direct connection or a transmission medium such as a local-area network or a wide-area network, such as the Internet. The web server 804 communicates with a product catalog 806 that may also be stored on the same or different server than the web server 804, the product catalog 806 retrieves product data 812 and saves the users' responses 814 from the review wizard 803. A score processing server 808 retrieves existing reviews 816 from a review repository 810, which may also be stored on the same or different server than the score processing server 808, retrieves existing scores for related products 818, and saves newly generated computer scores 820 for future retrieval by the score processing server 808.

Referring now also to FIG. 9, once an online user/shopper/customer has found a product of interest, the engine/method/system disclosed herein will find the most relevant swap alternatives using the following process for alternatives. For any given product in which a user is interested in purchasing, i.e., the input data, a list of alternative products will be generated, for example sustainable products. Output data is generated which includes a list of products ranked by the attribute score 104 and a similarity score 904. Characteristics of a given or chosen product are retrieved and a filter is generated to search for these characteristics in other products. Alternative products are looked up in a database, comparing the characteristics of the given or chosen product with other products. Each record is then assigned a similarity score (a float number) from 0 to 1, where 0=no similarity and 1=identical. Only products with a similarity score greater than a predetermined threshold, e.g., 0.7, are considered valid alternatives. In various embodiments, the predetermined threshold value may be different. The resulting list is ranked based on the attribute score 104, in the present embodiment sustainability.

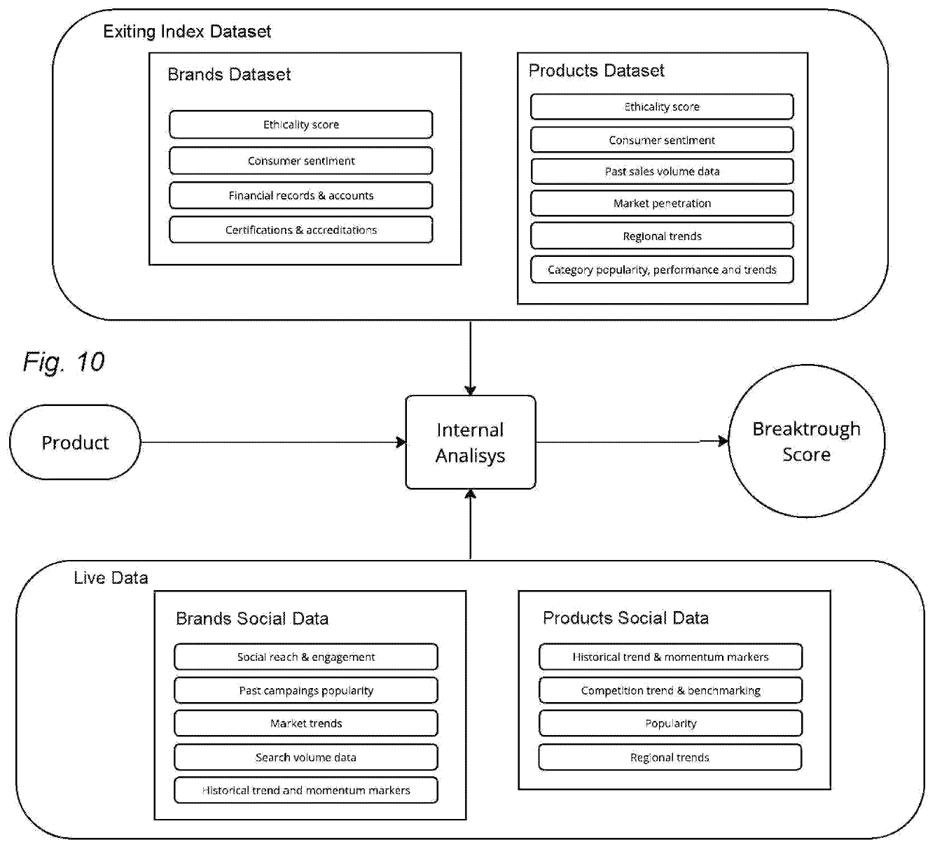

Referring to FIG. 10 there is shown is an object illustration diagram of the system for the score processing. Once each required product and/or company have the necessary input data analysis and scoring, a Breakthrough Score can be generated. For breakthrough ccore generation, once the data has been normalized a subset of the data for a chosen space is created, i.e., the subsets can be region specific, category specific, or any subset according to the desired requirements, and can be as granular as the data allows. Once the subset has been selected the weights for each variable are calculated to attain maximum precision. By normalizing the data, choosing the subset, and applying weights to the variables a breakthrough score can be calculated to generate a ranked list of the most competitive companies in the chosen space.

Each product has a list of attributes stored in a database, including, but not limited to, one or more of the following: ingredients, nutritional value, tokenized description, a list of categories, etc. The list of attributes' categories may vary with different products and may include more or less of the examples presented herein, and in other embodiments, may include one or more different attributes than those presented herein as an example. The sustainability score or attribute score 104, as discussed above, is a score calculated based on the public's opinion on a particular product's attributes, for example sustainability, as well as the company's attributes, for example the sustainability score of the brand. Data is obtained by allowing the public to review a product and brand, by answering a series of questions, grouped in “question groups,” as shown and described herein with respect to FIGS. 6-7.

In various embodiments, each score has two components: a product score; and a company or brand score. A product score, in some embodiments, is a computed product score and a computed company score. A company score is a computed company score and average of computed product scores of the brand. Each score is saved as a pure score and an aggregated score. The pure score includes only reviews of a specific product or brand. The aggregated score contains the pure score and the average of scores of related entities, e.g., for products, the score of the brand; for company, the average of the products score.

The term “question,” as discussed herein, means, in some embodiments, a question that is aimed at measuring the user's opinion about an aspect of a product's attributes, for example sustainability. In various embodiments, each question includes 5 answers, graded from 1 to 10. However, in other embodiments, each question may have more than, or less than, 5 answers, and the grading may vary, e.g., from 1 to 5 and/or from 1 to 100, and anything in between, above, or below these numbers. As will be appreciated, the number of questions, answers, and grading scale may be varied, as would be known to one of skill in the art.

The term “question group,” as discussed herein, is associated to a group. A group represents an aspect of a product's attributes, for example sustainability. Answers to questions within a question group are averaged and a score is computed for each group, for each product.

Each question group has a weight that defines the importance in the final score.

In various embodiments, when a swap is suggested and the user/consumer chooses to swap the product, incentives may be awarded, e.g., tokens/coins, plant a tree, etc., to reward the user for swapping the product for a more sustainable product. In various embodiments, the tokens/coins may be used to buy additional products, i.e., similar to store credit.

In various embodiments, all data on any given product, including, but not limited to, the list of ingredients, marketing slogans, etc., may be broken into keywords. Using these keywords, the platform/engine/method stiches together and ranks similarity based on the number of keywords shared between the products. The engine/method uses a learning algorithm that refines the results through human interaction via the suggested alterative feature on the platform. For example, if a customer recommends product X as a sustainable alternative to product Y, that creates: a) a match between those products that supersedes the keyword matching; and b) refinement of the algorithm by weighting certain keywords that already match.

Once products are matched by similarity, the engine/method ranks them by their attribute score 104 to give the top suggested swaps. Attribute scores 104 are driven by crowd-sourced aggregation of consumer reviews.

Various embodiments enable a user to view the analysis and ranking of companies and products based upon their likelihood to succeed in the future. The analysis and ranking is based upon historical and current popularity, consumer sentiment, sales, trend, ethicality and financial health data. Historical performance data for a given product or company is set against key success indicators to predict its future likelihood to be popular and financially successful.

Popularity data includes, but is not limited to, consumer sentiment, brand awareness data, social media presence in terms of reach, engagement, quality of content and regularity, and can be reduced by any negative data for example, lawsuits or recalls. Sales and financial health data includes, but is not limited to, historical revenue, financial records, accounts receivable and payable, and published records, to name a few.

Popularity, sales, trend, ethicality and financial health data are given separate scores out of 100 based on several criteria, weighted and blended to create a single breakthrough score, which is the overall predator score of future success. To build a Breakthrough Score, individual scores for popularity, sales, trend, ethicality and financial health data for each product and company may be utilized.

Companies may be clustered into subgroups depending for example a subgroup for company size, a subgroup for location, etc., with parameters to determine member of the subgroup, for example size of the company may be determined by a variety of factors including, for example the number of employees, sales, and the age of the company etc. The system and method described herein normalizes the data in each subgroup and across all variables to make the data comparable. By using deep learning techniques, the weights assigned to popularity metrics like social media followers and website traffic are adjusted dynamically based on historical data patterns. This ensures that the predictive system algorithm remains accurate and adaptable to changing business contexts.

The computer readable medium as described herein can be any know or future data storage device read by a a computer. Further, it will be appreciated that the term “memory” herein is intended to include various types of suitable data storage media, whether permanent or temporary, such as transitory electronic memories, non-transitory computer-readable medium and/or computer-writable medium.

It is to be understood that the present disclosure can be implemented in various forms of hardware, software, firmware, special purpose processes, or a combination thereof. In one embodiment, the present disclosure can be implemented in software as an application program embodied on a computer readable program storage device or via a transmission medium such as a local-area network or a wide-area network, such as the Internet. The application program can be uploaded to, and executed by, a machine comprising any suitable architecture. It is to be further understood that because some of the constituent system components and method steps depicted in the accompanying Figures can be implemented in software, the actual connections between the systems components (or the process steps) may differ depending upon the manner in which the present disclosure is programmed. Given the teachings of the present disclosure provided herein, one of ordinary skill in the related art will be able to contemplate these and similar implementations or configurations.

A number of embodiments have been described herein. Other embodiments are contemplated within the scope of the present disclosure in addition to the exemplary embodiments shown and described herein. As such, it will be understood that various modifications may be made without departing from the scope of the disclosure. In addition, although operations are depicted in the drawings in a particular order, this should not be understood as requiring that such operations be performed in the particular order shown or in sequential order, or that all illustrated operations be performed, to achieve desirable results.

In addition, it is to be understood that the phraseology and terminology used herein is for the purpose of description and should not be regarded as limiting. The use of “including,” “comprising,” “containing,” “involving,” or “having,” and variations thereof herein, is meant to encompass the items listed thereafter and equivalents thereof as well as additional items while only the terms “consisting only of” or “consisting essentially of” are to be construed in a limitative sense. References to “or” may be construed as inclusive so that any terms described using “or” may indicate any of a single, more than one, and all of the described terms. The terms Company and Companies are used interchangeably with the terms Business and Businesses and reference similar and/or the same concepts and also should not be construed as limiting.

Further, the purpose of the Abstract is to enable the U. S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to limit the claims in any way.

What is claimed:

1. A computer-implemented method for swapping a product selected for purchase by a user for an alternative product, the method comprising:
a computer network including one or more servers that operate to receive, analyze and store data;
accessing the computer network from at least one external user interface to input data for the selected product;
storing the input data on one of the one or more servers as a product catalog database;
retrieving the input data from the product catalog database;
analyzing the input data to determine a company score for a source of the selected product and a product score for the selected product;
saving the company score and the product score on one of the at least one or more servers in a reviews repository;
analyzing the company score and the product score to determine an attribute score of the selected product;
saving the attribute score of the selected product to one of the at least one or more servers in the reviews repository;
collecting data comprising explicit data and implicit data for alternative products;
analyzing the explicit data and implicit data to identify alternative products that are similar to the selected product;
calculating a corresponding attribute score for each of the identified alternative products;
filtering out alternative products whose attribute scores are lower than the selected product;
saving the attribute score for each of the alternative products to one of the at least one or more servers in the reviews repository;
ranking remaining alternative products by both similarity of the alternative product to the selected product and by the alternative products attribute score;
displaying the alternative products with the highest scores from the reviews repository through the user interface;
selecting a swapping product from the alternative products that are displayed; and
replacing the selected product with the swapping product.

2. The computer implemented method according to claim 1, further comprising calculating a breakthrough score as an indication of predicted success of a product, wherein the breakthrough score is calculated using source data provided by the source of the product and blending it with third-party analytics data, both types of data being accessed by the computer network and saved on one of the one or more servers.

3. The computer-implemented method according to claim 2, further comprising the step of using the breakthrough score to calculate the attribute score.

4. The computer-implemented method according to claim 3, wherein the attribute score is a sustainability score.

5. The computer implemented method according to claim 4, wherein the lower the sustainability score the higher the ecological impact of a product and the higher the sustainability score the lower the ecological impact of the product.

6. The computer-implemented method according to claim 1, further comprising loading a review wizard through the computer network; preparing questions for the user to answer; displaying the questions to the user and saving the user's answers to the product catalog database.

7. The computer-implemented method according to claim 1, wherein the explicit data includes attributes about the alternative products that are quantifiable and the implicit data is collected from behavior of users of the alternative products.

8. The computer-implemented method according to claim 7, wherein the explicit data is selected from the group consisting of product ingredients, nutrients, allergens, manufacturer, and packaging.

9. The computer-implemented method according to claim 7, wherein the implicit data is collected from historical data of users interacting with the alternative products.

10. The computer-implemented method according to claim 9, wherein the historical data of users is selected from the group consisting of website pageviews, clicks on the alternative products, number of shopping carts containing the alternative products, users' search records, advertising, and social media posts about the alternative products.

11. The computer-implemented method according to claim 1, wherein the product is a business.

12. An system for determining a sustainability score for a selected product and swapping a selected product for an alternative product chosen from a group of alternative products having a higher sustainability score, the system comprising:
a product catalog database stored on at least one server including input data collected from user responses and product data for both the selected product and the alternative products;
a reviews repository database stored on a at least one server including product scores and product supplier scores;
at least one processer that receives data for the selected product and the alternative products, analyzes, and stores the data;
at least one processor scorer that calculates a sustainability score for the selected product and the alternative products from both the product scores and the product supplier scores associated with the selected product and with the alternative products;
at least one processor ranker that ranks the alternative products for swapping by both similarity and sustainability score; and
at least one processor selector for a swapping product from the products similar to the selected product, wherein the swapping product ranks high in similarity to the selected product, and has a corresponding sustainability score higher than the sustainability score of the selected product; and
an interface for presenting the selected swapping product; and swapping the selected product with the swapping product.

13. The system for swapping a selected product for an alternative product wherein the at least one processor that receives data and analyzes the data to identify similar alternative products includes a processor searcher, wherein similarity is determined by data related to one or more of the character, quality and capabilities of the alternative products.

14. The system for swapping a selected product for an alternative product according to claim 1, further comprising a breakthrough score as an indication of predicted success of a product, wherein the breakthrough score is calculated using source data provided by the source of the product and blending it with third-party analytics data, both types of data being accessed by the computer network and saved on one of the one or more servers.

15. The system for swapping a selected product for an alternative product according to claim 14, wherein the breakthrough score is used to calculate the attribute score.

16. The system for swapping a selected product for an alternative product having a higher sustainability score of claim 12, wherein the product is a business.

17. The system for swapping a selected product for an alternative product according to claim 12, wherein the sustainability score is calculated to include one of the product performance data and product historical popularity.

18. The system for swapping a selected product for an alternative product according to claim 12, wherein the product is a business.
